(19) United States
(12) Patent Application Publication
(10) Pub. No.: US 2026/0142894 A1
(43) Pub. Date: May 21, 2026

(54) ANOMALY DETECTION FOR NETWORK GUARDS USING DEEP AUTO ENCODERS

(71) Applicant: QUALCOMM Incorporated, San Diego, CA (US)

(72) Inventors: Gal IZHAKI, Haifa (IL); Daniel YELLIN, Raanana (IL)

(21) Appl. No.: 18/949,926

(22) Filed: Nov. 15, 2024

(51) Int. Cl. H04L 41/5009; H04L 41/16

(52) U.S. Cl. CPC H04L 41/5009; H04L 41/16

(57) ABSTRACT

This disclosure provides systems, methods and apparatus, including computer programs encoded on computer storage media, for anomaly detection for network guards using deep auto encoders. Techniques described herein may enable a management device to use a deep auto encoder (DAE) to detect an anomaly associated with one or more key performance indicators (KPIs) of a wireless communications system. For example, the management device may provide the one or more KPIs as an input to the DAE, and the DAE may determine if the one or more KPIs include a performance change. The DAE may encode and decode the KPIs using one or more neural networks (NNs). The DAE may detect a performance change based on computing a difference between the input KPIs and the decoded KPIs. The management device may adjust one or more parameters in response to detecting the performance change.

### TECHNICAL FIELD

This disclosure relates to wireless communications, including anomaly detection for network guards using deep auto encoders (DAEs).

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-s-OFDM). A wireless multiple-access communications system may include one or more base stations (BSs) or one or more network access nodes, each simultaneously supporting communication for multiple communication devices, which may be otherwise known as user equipment (UE).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a management entity. The method may include obtaining a set of multiple key performance indicators (KPIs) associated with a set of multiple cells of a wireless communications network, receiving, in accordance with an output of a deep auto encoder (DAE), an indication of a performance change in at least one KPI of the set of multiple KPIs associated with the set of multiple cells, and outputting one or more messages in accordance with receiving the indication of the performance change.

Another innovative aspect of the subject matter described in this disclosure can be implemented in a management entity for wireless communications. The management entity may include one or more memories storing processor-executable code, and one or more processors coupled with the one or more memories. The one or more processors may individually or collectively be operable to execute the code to cause the management entity to obtain a set of multiple KPIs associated with a set of multiple cells of a wireless communications network, receive, in accordance with an output of a DAE, an indication of a performance change in at least one KPI of the set of multiple KPIs associated with the set of multiple cells, and output one or more messages in accordance with receiving the indication of the performance change.

Another innovative aspect of the subject matter described in this disclosure can be implemented in a management entity for wireless communications. The management entity may include means for obtaining a set of multiple KPIs associated with a set of multiple cells of a wireless communications network, means for receiving, in accordance with an output of a DAE, an indication of a performance change in at least one KPI of the set of multiple KPIs associated with the set of multiple cells, and means for outputting one or more messages in accordance with receiving the indication of the performance change.

Another innovative aspect of the subject matter described in this disclosure can be implemented in a non-transitory computer-readable medium storing code for wireless communications. The code may include instructions executable by one or more processors to obtain a set of multiple KPIs associated with a set of multiple cells of a wireless communications network, receive, in accordance with an output of a DAE, an indication of a performance change in at least one KPI of the set of multiple KPIs associated with the set of multiple cells, and output one or more messages in accordance with receiving the indication of the performance change.

Some examples of the method, management entities, and non-transitory computer-readable medium described herein may further include operations, features, means, or instructions for receiving the indication of the performance change may be in accordance with computing one or more differences between the set of multiple KPIs and the output of the DAE.

Some examples of the method, management entities, and non-transitory computer-readable medium described herein may further include operations, features, means, or instructions for training the DAE in accordance with a first set of KPI values associated with the set of multiple cells, where the first set of KPI values may be associated with an absence of performance changes.

In some examples of the method, management entities, and non-transitory computer-readable medium described herein, receiving the indication of the performance change may include operations, features, means, or instructions for receiving an indication of a cell of the set of multiple cells associated with the performance change, an indication of a KPI type associated with the performance change, an indication of whether the performance change includes an improvement or a degradation, or any combination thereof.

In some examples of the method, management entities, and non-transitory computer-readable medium described herein, the set of multiple KPIs include KPIs from the set of multiple cells that may be associated with a same day of the week, a same time of day, a same range of days of the week, or any combination thereof.

Some examples of the method, management entities, and non-transitory computer-readable medium described herein may further include operations, features, means, or instructions for outputting, to one or more cells of the set of multiple cells, an indication of a first change in a configuration associated with the one or more cells, where the performance change may be associated with the first change in the configuration.

In some examples of the method, management entities, and non-transitory computer-readable medium described herein, outputting the one or more messages may include operations, features, means, or instructions for outputting, to one or more cells of the set of multiple cells, an indication of a second change in the configuration associated with the one or more cells.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example of a wireless communications system that supports anomaly detection for network guards using deep auto encoders (DAEs).

FIG. 2 shows an example of a signaling diagram that supports anomaly detection for network guards using DAEs.

FIG. 3 shows an example of a DAE diagram that supports anomaly detection for network guards using DAEs.

FIG. 4 shows an example of a process flow that supports anomaly detection for network guards using DAEs.

FIG. 5 shows a diagram of a system including a device that supports anomaly detection for network guards using DAEs.

FIG. 6 shows a flowchart illustrating methods that support anomaly detection for network guards using DAEs.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system, or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing third generation (3G), fourth generation (4G), fifth generation (5G), or sixth generation (6G), or further implementations thereof, technology.

In some wireless communications systems, a management entity (such as a service management and orchestration (SMO) layer or an edgewise suite) may communicate with one or more network entities (such as network entities associated with one or more cells). For example, the management entity may indicate for the one or more network entities to adjust one or more parameters of a configuration (such as parameters associated with signal strength, handover procedures, and the like) used by the one or more network entities to communicate with various user equipments (UEs). In some examples, adjusting the parameters may result in performance degradation or performance improvement. For example, adjusting the parameters may result in a performance change associated with a key performance indicator (KPI) of the wireless communication system, such as throughput or handover success rate. Accordingly, the management entity may perform one or more network guard operations related to a performance degradation. One approach may include performing a rollback of the parameter adjustment. In such instances, the KPI may change for one or more other reasons (such as an increase in traffic related to a beginning of a working day, a decrease in traffic related to a holiday, or natural self-variability of that KPI), and the management entity may be unaware if performance is changing due to the adjusted parameters or for another reason.

Various aspects generally relate to a management entity that may use a deep auto encoder (DAE) to detect a performance change associated with one or more KPIs of the wireless communications system. Various aspects relate more specifically to methods for the management entity to provide the one or more KPIs as an input to the DAE. The DAE may encode the KPIs using one or more neural networks (NNs) and decode the KPIs using one or more NNs to generate one or more decoded KPIs. In some examples, the NNs of the DAE may be trained using a set of data collected during a reference period, such as a period prior to the configuration change. The management device may receive an output of the DAE, which may include one or more differences between the input KPIs and the decoded KPIs. The management device may accordingly determine if the one or more KPIs include a performance change (such as an anomaly). For example, the management entity may determine that a performance change is present if the one or more differences between the input KPIs and the decoded KPIs satisfy a threshold. The management entity may accordingly perform one or more network guard operations to adjust one or more parameters (such as performing a rollback of a configuration change), refrain from adjusting the one or more parameters, or output a notification in response to detecting the performance change.

Particular implementations of the subject matter described in this disclosure can be implemented to realize one or more of the following potential advantages. The techniques employed by the described communication devices may provide benefits and enhancements to the operation of the communication devices, including relatively increased quality of communications. For example, operations performed by the described communication devices may enable a management device to determine, detect, identify, or obtain whether a performance change has occurred in one or more cells. In some implementations, operations performed by the described communication devices also may support improvements to reliability, increased coordination between devices, and relatively more efficient utilization of resources, among other benefits, by allowing the management entity to use a DAE to identify a source of a performance change (such as a configuration change that resulted in a performance change), which may enable the management entity to adapt a configuration to improve performance (such as throughput, handover success rate, and the like) of the one or more cells.

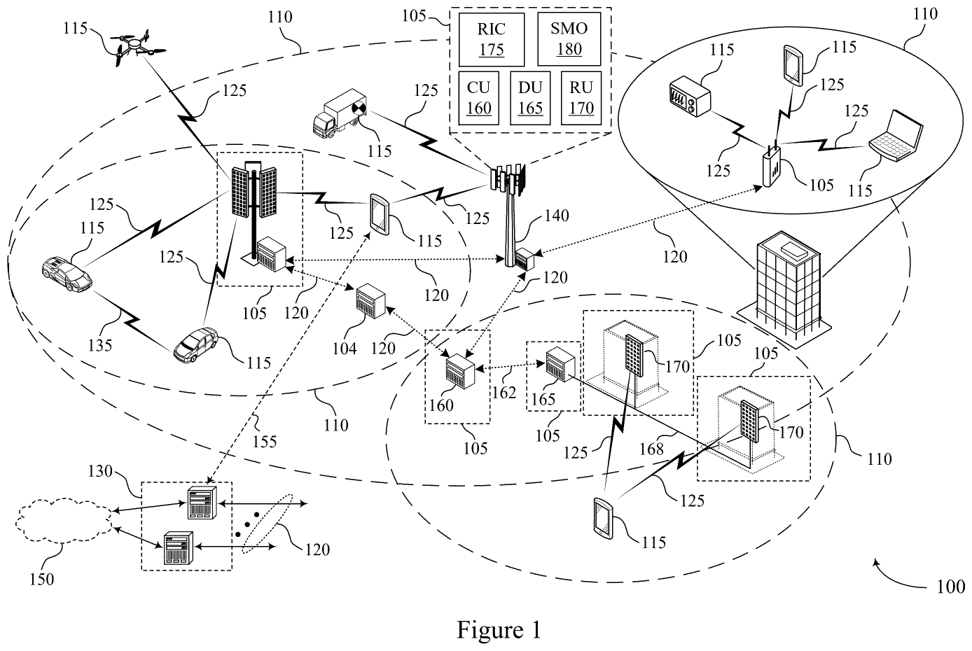

FIG. 1 shows an example of a wireless communications system 100 that supports anomaly detection for network guards using DAEs. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (such as a radio frequency (RF) access link). For example, a network entity 105 may support a coverage area 110 (such as a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (such as any network entity described herein), a UE 115 (such as any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some implementations, network entities 105 may communicate with the core network 130, or with one another, or both. For example, network entities 105 may communicate with the core network 130 via one or more backhaul communication links 120 (such as in accordance with an S1, N2, N3, or other interface protocol). In some implementations, network entities 105 may communicate with one another via a backhaul communication link 120 (such as in accordance with an X2, Xn, or another interface protocol) either directly (such as directly between network entities 105) or indirectly (such as via a core network 130). In some implementations, network entities 105 may communicate with one another via a midhaul communication link 162 (such as in accordance with a midhaul interface protocol) or a fronthaul communication link 168 (such as in accordance with a fronthaul interface protocol), or any combination thereof. The backhaul communication links 120, midhaul communication links 162, or fronthaul communication links 168 may be or include one or more wired links (such as an electrical link, an optical fiber link), one or more wireless links (such as a radio link, a wireless optical link), among other examples or various combinations thereof. A UE 115 may communicate with the core network 130 via a communication link 155.

One or more of the network entities 105 described herein may include or may be referred to as a base station (BS) 140 (such as a base transceiver station, a radio BS, an NR BS, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (such as a BS 140) may be implemented in an aggregated (such as monolithic, standalone) BS architecture, which may be configured to utilize a protocol stack that is physically or logically integrated within a single network entity 105 (such as a single RAN node, such as a BS 140).

In some implementations, a network entity 105 may be implemented in a disaggregated architecture (such as a disaggregated BS architecture, a disaggregated RAN architecture), which may be configured to utilize a protocol stack that is physically or logically distributed among two or more network entities 105, such as an integrated access backhaul (IAB) network, an open RAN (O-RAN) (such as a network configuration sponsored by the O-RAN Alliance), or a virtualized RAN (vRAN) (such as a cloud RAN (C-RAN)). For example, a network entity 105 may include one or more of a central unit (CU) 160, a distributed unit (DU) 165, a radio unit (RU) 170, a RAN Intelligent Controller (RIC) 175 (such as a Near-Real Time RIC (Near-RT RIC), a Non-Real Time RIC (Non-RT RIC)), a Service Management and Orchestration (SMO) 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (such as separate physical locations). In some implementations, one or more network entities 105 of a disaggregated RAN architecture may be implemented as virtual units (such as a virtual CU (VCU), a virtual DU (VDU), a virtual RU (VRU)).

The split of functionality between a CU 160, a DU 165, and an RU 170 is flexible and may support different functionalities depending on which functions (such as network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (such as layer 3 (L3), layer 2 (L2)) functionality and signaling (such as Radio Resource Control (RRC), service data adaptation protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (such as physical (PHY) layer) or L2 (such as radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (such as via one or more RUs 170). In some implementations, a functional split between a CU 160 and a DU 165, or between a DU 165 and an RU 170 may be within a protocol layer (such as some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (such as F1, F1-c, F1-u), and a DU 165 may be connected to one or more RUs 170 via a fronthaul communication link 168 (such as open fronthaul (FH) interface). In some implementations, a midhaul communication link 162 or a fronthaul communication link 168 may be implemented in accordance with an interface (such as a channel) between layers of a protocol stack supported by respective network entities 105 that are in communication via such communication links.

In wireless communications systems (such as wireless communications system 100), infrastructure and spectral resources for radio access may support wireless backhaul link capabilities to supplement wired backhaul connections, providing an IAB network architecture (such as to a core network 130). In some implementations, in an IAB network, one or more network entities 105 (such as IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (such as a donor BS 140). The one or more donor network entities 105 (such as IAB donors) may be in communication with one or more additional network entities 105 (such as IAB nodes 104) via supported access and backhaul links (such as backhaul communication links 120). IAB nodes 104 may include an IAB mobile termination (IAB-MT) controlled (such as scheduled) by DUs 165 of a coupled IAB donor. An IAB-MT may include an independent set of antennas for relay of communications with UEs 115, or may share the same antennas (such as of an RU 170) of an IAB node 104 used for access via the DU 165 of the IAB node 104 (such as referred to as virtual IAB-MT (vIAB-MT)). In some implementations, the IAB nodes 104 may include DUs 165 that support communication links with additional entities (such as IAB nodes 104, UEs 115) within the relay chain or configuration of the access network (such as downstream). In such implementations, one or more components of the disaggregated RAN architecture (such as one or more IAB nodes 104 or components of IAB nodes 104) may be configured to operate according to the techniques described herein.

In the implementation of the techniques described herein applied in the context of a disaggregated RAN architecture, one or more components of the disaggregated RAN architecture may be configured to support anomaly detection for network guards using DAEs as described herein. For example, some operations described as being performed by a UE 115 or a network entity 105 (such as a BS 140) may additionally, or alternatively, be performed by one or more components of the disaggregated RAN architecture (such as IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay BSs, among other examples, as shown in FIG. 1.

The UEs 115 and the network entities 105 may wirelessly communicate with one another via one or more communication links 125 (such as an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (such as entity, sub-entity) of a network entity 105. For example, the terms “transmitting,” “receiving,” or “communicating,” when referring to a network entity 105, may refer to any portion of a network entity 105 (such as a BS 140, a CU 160, a DU 165, a RU 170) of a RAN communicating with another device (such as directly or via one or more other network entities 105).

Signal waveforms transmitted via a carrier may be made up of multiple subcarriers (such as using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (such as a duration of one modulation symbol) and one subcarrier, for which the symbol period and subcarrier spacing may be inversely related. The quantity of bits carried by each resource element may depend on the modulation scheme (such as the order of the modulation scheme, the coding rate of the modulation scheme, or both), such that a relatively higher quantity of resource elements (such as in a transmission duration) and a relatively higher order of a modulation scheme may correspond to a relatively higher rate of communication. A wireless communications resource may refer to a combination of an RF spectrum resource, a time resource, and a spatial resource (such as a spatial layer, a beam), and the use of multiple spatial resources may increase the data rate or data integrity for communications with a UE 115.

The time intervals for the network entities 105 or the UEs 115 may be expressed in multiples of a basic time unit which may, in some implementations, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (such as 10 milliseconds (ms)). Each radio frame may be identified by a system frame number (SFN) (such as ranging from 0 to 1023).

Each frame may include multiple consecutively numbered subframes or slots, and each subframe or slot may have the same duration. In some implementations, a frame may be divided (such as in the time domain) into subframes, and each subframe may be further divided into a quantity of slots. Alternatively, each frame may include a variable quantity of slots, and the quantity of slots may depend on subcarrier spacing. Each slot may include a quantity of symbol periods (such as depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (such as N_{f}) sampling periods. The duration of a symbol period may depend on the subcarrier spacing or frequency band of operation.

A subframe, a slot, a mini-slot, or a symbol may be the smallest scheduling unit (such as in the time domain) of the wireless communications system 100 and may be referred to as a transmission time interval (TTI). In some implementations, the TTI duration (such as a quantity of symbol periods in a TTI) may be variable. Additionally, or alternatively, the smallest scheduling unit of the wireless communications system 100 may be dynamically selected (such as in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (such as a control resource set (CORESET)) for a physical control channel may be defined by a set of symbol periods and may extend across the system bandwidth or a subset of the system bandwidth of the carrier. One or more control regions (such as CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (such as control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (such as using a carrier) and may be associated with an identifier for distinguishing neighboring cells (such as a physical cell identifier (PCID), a virtual cell identifier (VCID), or others). In some implementations, a cell also may refer to a coverage area 110 or a portion of a coverage area 110 (such as a sector) over which the logical communication entity operates. Such cells may range from smaller areas (such as a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (such as several kilometers in radius) and may allow unrestricted access by the UEs 115 with service subscriptions with the network provider supporting the macro cell. A small cell may be associated with a lower-powered network entity 105 (such as a lower-powered BS 140), as compared with a macro cell, and a small cell may operate using the same or different (such as licensed, unlicensed) frequency bands as macro cells. Small cells may provide unrestricted access to the UEs 115 with service subscriptions with the network provider or may provide restricted access to the UEs 115 having an association with the small cell (such as the UEs 115 in a closed subscriber group (CSG), the UEs 115 associated with users in a home or office). A network entity 105 may support one or multiple cells and also may support communications via the one or more cells using one or multiple component carriers.

In some implementations, a carrier may support multiple cells, and different cells may be configured according to different protocol types (such as MTC, narrowband IoT (NB-IoT), enhanced mobile broadband (eMBB)) that may provide access for different types of devices.

In some implementations, a network entity 105 (such as a BS 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be configured to support communicating directly with other UEs 115 via a device-to-device (D2D) communication link 135 (such as in accordance with a peer-to-peer (P2P), D2D, or sidelink protocol). In some implementations, one or more UEs 115 of a group that are performing D2D communications may be within the coverage area 110 of a network entity 105 (such as a BS 140, an RU 170), which may support aspects of such D2D communications being configured by (such as scheduled by) the network entity 105. In some implementations, one or more UEs 115 of such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (such as a mobility management entity (MME), an access and mobility management function (AMF)) and at least one user plane entity that routes packets or interconnects to external networks (such as a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (such as BSs 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (such as less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some implementations, operations using unlicensed bands may be based on a carrier aggregation configuration in conjunction with component carriers operating using a licensed band (such as LAA). Operations using unlicensed spectrum may include downlink transmissions, uplink transmissions, P2P transmissions, or D2D transmissions, among other examples.

A network entity 105 (such as a BS 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (such as the same codeword) or different data streams (such as different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which also may be referred to as spatial filtering, directional transmission, or directional reception, is a signal processing technique that may be used at a transmitting device or a receiving device (such as a network entity 105, a UE 115) to shape or steer an antenna beam (such as a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (such as with respect to the antenna array of the transmitting device or receiving device, or with respect to some other orientation).

A network entity 105 or a UE 115 may use beam sweeping techniques as part of beamforming operations. For example, a network entity 105 (such as a BS 140, an RU 170) may use multiple antennas or antenna arrays (such as antenna panels) to conduct beamforming operations for directional communications with a UE 115. Some signals (such as synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (such as by a transmitting device, such as a network entity 105, or by a receiving device, such as a UE 115) a beam direction for later transmission or reception by the network entity 105.

Some signals, such as data signals associated with a particular receiving device, may be transmitted by transmitting device (such as a transmitting network entity 105, a transmitting UE 115) along a single beam direction (such as a direction associated with the receiving device, such as a receiving network entity 105 or a receiving UE 115). In some implementations, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some implementations, transmissions by a device (such as by a network entity 105 or a UE 115) may be performed using multiple beam directions, and the device may use a combination of digital precoding or beamforming to generate a combined beam for transmission (such as from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (such as a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (such as a multi-panel type codebook, a linear combination type codebook, a port selection type codebook). Although these techniques are described with reference to signals transmitted along one or more directions by a network entity 105 (such as a BS 140, an RU 170), a UE 115 may employ similar techniques for transmitting signals multiple times along different directions (such as for identifying a beam direction for subsequent transmission or reception by the UE 115) or for transmitting a signal along a single direction (such as for transmitting data to a receiving device).

A receiving device (such as a UE 115) may perform reception operations in accordance with multiple receive configurations (such as directional listening) when receiving various signals from a transmitting device (such as a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (such as different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (such as when receiving a data signal). The single receive configuration may be aligned along a beam direction determined based on listening according to different receive configuration directions (such as a beam direction determined to have a highest signal strength, highest signal-to-noise ratio (SNR), or otherwise acceptable signal quality based on listening according to multiple beam directions).

Certain aspects and techniques as described herein may be implemented, at least in part, using an artificial intelligence (AI) program, such as a program that includes a ML or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to perform performance change detection using a DAE as described herein. Thus, during operation of a device, the ML model may receive input data (such as observed KPI) and make inferences (such as a performance change that occurred based on a configuration change) based on the weights and biases.

ML models may be deployed in one or more devices (such as SMOs, network entities, and UEs) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models to detect performance changes. To facilitate the discussion, an ML model configured using one or more NNs is used, but it should be understood, that other types of ML models may be used instead of a NN. Hence, unless expressly recited, subject matter regarding an ML model is not necessarily intended to be limited to a NN solution. Further, it should be understood that, unless otherwise specifically stated, terms such “AI/ML model,” “ML model,” “trained ML model,” “ANN,” “model,” “algorithm,” or the like are intended to be interchangeable.

In example aspects, an ML model may be trained prior to, or at some point following, operation of the ML model on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a UE 115 or other device in a wireless communication system, or one or more network entities, or aggregated from multiple sources (such as a UE 115 and a network entity/entities 105, one or more other UEs 115, the Internet, or the like). For example, wireless network architectures, such as self-organizing networks (SONs) (such as distributed SONs (dSONs)) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Once a NN has been configured by setting parameters, including weights and biases, from training data, the NN's performance may be evaluated. In some scenarios, evaluation/verification tests may use a validation dataset, which may include data not in the training data, to compare the model's performance to baseline or other benchmark information. The NN configuration may be further refined, for example, by changing its architecture, re-training it on the data, or using different optimization techniques, etc.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a CU, a DU, a RU, or the like.

In some examples of the wireless communications system 100, a management device (such as an SMO 180) may use a DAE to detect a performance change (which may be performance improvement or a performance degradation) associated with one or more KPIs associated with cells of one or more network entities 105. For example, in response to adjusting a configuration of the cells, the management device may provide the one or more KPIs as an input to the DAE. The management entity may determine if the one or more KPIs include a performance change by encoding the KPIs in the DAE using one or more NNs and decoding the KPIs using one or more NNs of the DAE to generate an output of one or more decoded KPIs and comparing the DAE inputs to the outputs. The NNs of the DAE may determine correlations between the KPIs (such as automatically as part of the encoding and decoding process) and may utilize them to generate outputs that may match the inputs to the DAE. The management entity may compare the input KPIs to the decoded KPIs and may determine whether a performance change is present based on a difference between the input KPIs to the decoded KPIs. In some examples (such as a normal operation when no change in performance occurs), the difference may be a function of the normal fluctuations of the chosen KPIs and the ability of the DAE to predict them. However, if a change in performance occurs (such as due to a change in a configuration), the difference may reflect both the normal fluctuations of the KPIs and also the change in performance. The management entity may therefore utilize the difference to determine if this change corresponds to a performance improvement (such as the throughput of a cell improved) or a performance degradation (such as the handoff success rate of users of that cell decreased), to generate a desired action. For example, the desired action may accordingly be one or more network guard operations, such as by adjusting the one or more parameters (such as outputting, to the cells, a configuration change or a rollback to a previous configuration change), may refrain from adjusting the one or more parameters, or may output a notification in response to detecting the performance degradation. In examples in which a performance improvement (such as a desired change) is detected, the management entity may record the newly used set of parameters and may apply them to other cells in the network. In some examples, the management entity may generate a report stating the detected performance improvement.

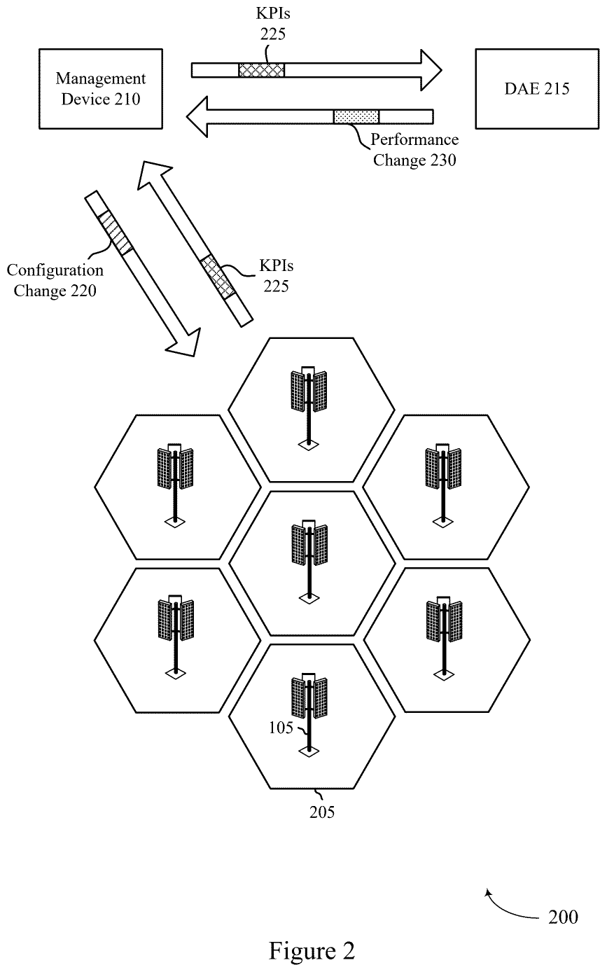

FIG. 2 shows an example of a signaling diagram 200 that supports anomaly detection for network guards using DAEs. The signaling diagram 200 may implement or may be implemented by aspects of the wireless communications system 100. For example, the signaling diagram 200 may be implemented by one or more cells 205 of network entities 105, which may be examples of network entities 105 as described with reference to FIG. 1, and a management device 210, which may be an example of an SMO 180 as described with reference to FIG. 1.

In some examples of the signaling diagram 200, a management device 210 (such as an SMO or an edgewise suite) may output a configuration change 220 to a set of cells 205 (such as a cluster of cells associated with a set of network entities 105). The configuration change may include a change to a tilt used by the cells 205, an azimuth or angle above the ground associated with communications with the cells 205, a transmission power used by the cells 205, or another network parameter or knob change.

The cells 205 may indicate one or more KPIs 225 to the management device 210 that may indicate a performance associated with the cells 205 following the configuration change. For example, the KPIs may indicate a drop rate, an access failure rate, a quantity of handover attempts (such as a quantity determined based on a handover attempt counter), a quantity of successful handovers (such as a quantity determined based on a successful handover counter), a handover attempt success rate, a throughput, a latency, an accessibility, an uplink traffic volume, or a downlink traffic volume of the cells 205 following the configuration change 220. In some examples, the KPIs 225 may include one or more vendor-agnostic KPIs (such as KPIs representing a performance of cells of different vendors) or conditions associated with the cells 205. In some examples, the KPIs 225 may indicate that a performance of the cells 205 changed following the configuration change 220. As an illustrative example, the KPIs 225 may indicate that a throughput of the cells 205 decreased following the configuration change 220 (such as compared to a throughput measured and indicated to the management device 210 prior to the configuration change 220).

Accordingly, the management device 210 may perform a network guard operation in which the management device 210 may monitor performance changes (such as KPI changes) following network configuration changes to determine if the configuration change 220 degraded a performance of the cells 205. For example, the management device 210 may compare the KPIs 225 with one or more KPI thresholds (such as static thresholds), and may determine that the configuration change 220 degraded a performance of the cells 205 if the KPIs 225 satisfy the KPI thresholds. As an illustrative example, the management device 210 may output a configuration change 220 that indicates for one or more cells 205 to change a parameter that sets a signal strength of a handover operation (such as handover from a first layer to a second layer) by 3 decibels (dB). The management device 210 may determine if a KPI 225 (such as a dropped call rate (DCR)) satisfies a KPI threshold such as a DCR change threshold (such as a 10% degradation in the DCR as compared to a DCR during a reference period, such as 24 hours prior to the configuration change 220) following the configuration change 220 (such as during a configured assessment period, such as 24 hours following the configuration change 220). If the DCR satisfies the DCR threshold following the configuration change 220, the management device 210 may determine that the configuration change 220 degraded the performance of the cells 205. Accordingly, the management device 210 may determine to execute a rollback (or may automatically execute the rollback) of the configuration change 220.

In some examples, however, the KPIs 225 may change due to one or more factors different from the configuration change 220. For example, the KPIs 225 may change due to natural self-variability of counters associated with the KPIs 225. As an illustrative example, the management device 10 may output the configuration change 220 to the cells 205 at a first time on a weekday morning (such as 8 AM on Monday morning). However, the cells 205 may experience a regular increase in traffic at the first time on weekday mornings (such as even in an absence of a configuration change 220, as a result of a workday beginning), and the KPIs 225 may therefore change due to the regular traffic increase (such as rather than due to the configuration change 220).

Accordingly, to avoid false positives associated with performance change detection (such as incorrectly determining that a performance change is due to a configuration change 220), the KPI thresholds may be relatively large. However, such large KPI thresholds may result in false negatives (such as incorrectly determining that a performance change is not due to a configuration change 220), which may result in a relatively reduced quality of communications by the cells 205. For example, the management device 210 may not roll back a configuration change that may result in a KPI degradation, which may result in the KPI degradation decreasing the quality of communications (such as increasing a DCR, decreasing a throughput, increasing a failure rate of handover operations, and the like).

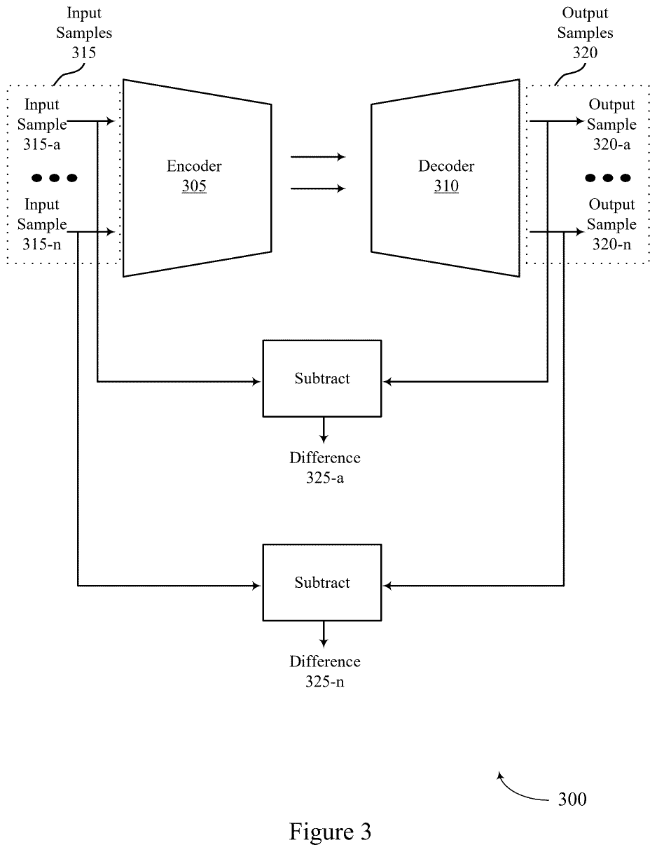

In some implementations, the management device 210 may use a DAE 215 to determine whether a performance change indicated by the KPIs 225 is due to a configuration change 220 or due to regular self-variance of the cells 205. For example, the management device 210 may input the KPIs 225 into the DAE 215. The DAE 215 may analyze the KPIs 225 of the cells 205 before and after the configuration change 220 to ignore a natural self-variability of the cells 205, which may enable the management device 210 to perform the network guard procedure and determine whether performance degradation or improvement may have occurred as a result of the configuration change 220. For example, the DAE 215 may encode (such as compress) and decode (such as decompress) the KPIs 225 (such as and one or more KPIs 225 associated with a reference period prior to the configuration change 220, which may include a previous day, a previous week, a previous year, and the like). The DAE 215 may determine that a performance change (such as a performance change that is not due to regular self-variance, which may be referred to herein as an anomaly) may have occurred if an error (such as a root mean-squared error (RMSE)) between the input to the DAE 215 and the decoded KPIs 225 is greater than an error threshold (such as a RMSE threshold or an alert threshold associated with a sensitivity of the DAE 215). Such techniques are described in further detail herein with reference to FIG. 3.

The management device 210 may therefore receive, from the DAE 215, an indication of a performance change 230 associated with the cells 205 that is due to the configuration change 220. In some examples, if the performance change 230 occurred for a given KPI 225 or for a given cell 205, the DAE 215 may output an indication of one or more KPIs 225 or one or more cells 205 associated with the performance change 230. Additionally, or alternatively, the DAE 215 may indicate whether the performance change 230 includes a performance improvement (such as a throughput increase, a handover success rate increase, a DCR decrease, and the like) or a performance degradation (such as a throughput decrease, a handover success rate decrease, a DCR increase, and the like).

The management device 210 may accordingly output an indication of the performance change. For example, the management device 210 may indicate to the cells 205 or to a mobile network operator (MNO) associated with the cells 205 whether the configuration change 220 resulted in a performance improvement or a performance degradation (or neither a performance improvement nor a performance degradation) and for which KPIs the performance change was detected (such as if the throughput improved and the handoff success rate did not change). Additionally, or alternatively, the management device 210 may output an additional configuration change 220 in response to receiving the indication of the performance change 230. For example, if the configuration change 220 resulted in a performance degradation, the management device 210 may output a roll back of the configuration change 220.

Such techniques may enable the MNO to configure one or more rules associated with monitoring the performance of the cells 205. For example, the MNO may configure the management device 210 to automatically roll back a configuration change 220 in response to determining that the configuration change 220 resulted in a performance degradation in accordance with an output of the DAE 215. Additionally, the described techniques may enable the DAE 215 to identify a constant reference data set (such as a set of previously-measured KPIs) rather than manually selecting data collected during a reference period (such as data collected during a manually selected 24 hour period prior to the configuration change 220), which may result in a relatively faster identification of performance changes 230.

In some implementations, the management device 210 may perform a pre-processing of one or more of the KPIs 225 (such as prior to inputting the KPIs 225 into the DAE 215). For example, one or more KPIs 225 may be counters that measure a success rate or failure rate (and may therefore be between 0 and 1). In some examples, the management device 210 may calculate the success rate or failure rate by computing a ratio of a quantity of attempts and a quantity of success or failures. As an illustrative example, to compute a DCR, the management device 210 may compute a ratio of a pair of KPIs 225 KPIₙ and KPIₖ (such as a quantity of calls num_calls and a quantity of dropped calls num_calls_that_dropped, respectively). Additionally, or alternatively, to compute a handoff success rate, the management device 210 may compute a ratio of a pair of KPIs 225 KPIₙ and KPIₖ (such as a quantity of handoff attempts num_of_handoff_attempts and a quantity of successful handovers number_of_handoff_successes, respectively). Such KPIs 225 that measure a success rate or failure rate may be referred to herein as binomial-like KPIs.

For such binomial-like KPIs, the management device 210 may compute a ratio a/b of binomial distributions as an input into the DAE 215. For example, the binomial distributions a and b may be defined as

$$a = \frac{{KPI}_{n} !}{{KPI}_{k} ! * ( {KPI}_{n} - {KPI}_{k} ) !} * {\hat{p}}^{{KPI}_{k}} * {( 1 - \hat{p} )}^{{KPI}_{n} - {KPI}_{k}} \\ and \\ b = \frac{{KPI}_{n} !}{{KPI}_{\hat{k}} ! * ( {KPI}_{n} - {KPI}_{\hat{k}} ) !} * {\hat{p}}^{{KPI}_{k}} * {( 1 - \hat{p} )}^{{KPI}_{n} - {KPI}_{\hat{k}}} ,$$

where “!” is the factorial operation

$$\hat{p} = \frac{{KPI}_{k}}{{KPI}_{n}} ,$$

and KPI_{\hat{k}} may be a nearest integer (such as a rounded value) of \hat{p}*KPIₙ. In some examples, the management device 210 may compute the log of the ratio

$$\frac{a}{b} ( such as log ( \frac{a}{b} ) )$$

rather than the ratio a/b itself. Accordingly, the management device 210 may input a log likelihood, a normalized log likelihood, or a log value representing the binomial-like KPIs or any other KPI into the DAE 215.

In some implementations, the management device 210 may identify an assessment environment for determining whether a performance change 230 occurred as a result of the configuration change 220. For example, the management device 210 may obtain KPIs 225 associated with one or more cells 205 of the set of cells 205, associated with a horizontal cluster of cells (such as cells operating within a same frequency), associated with a vertical cluster of cells (such as cells operating under a same sector or with a same azimuth), and the like. As described herein, vertical and horizontal clusters of cells may be selected as a polygon to determine or otherwise ascertain performance degradation (such as for a carrier aggregation that is aggregating a spectrum of cells based on frequency or azimuth or both).

FIG. 3 shows an example of a DAE diagram 300 that supports anomaly detection for network guards using DAEs. The DAE diagram 300 may implement or may be implemented by aspects of the wireless communications system 100 or the signaling diagram 200. For example, the DAE diagram 300 may be implemented by one or more devices, such as an SMO 180, as described with reference to FIG. 1.

As described with reference to FIG. 2, a management device (such as an SMO or an edgewise suite) may use a DAE to determine whether one or more KPIs associated with a set of cells are associated with a performance change that is not due to regular self-variance (such as an anomaly). For example, the DAE may encode (such as compress) a set of input samples 315 (such as an input sample 315-a through an input sample 315-n) via an encoder 305. The encoder 305 may output a set of encoded samples, which may have a relatively smaller dimension than the input samples 315 (such as m samples as compared to n samples). The DAE may decode (such as decompress) the encoded samples via a decoder 310 to generate a set of output samples 320 (such as an output sample 320-a through an output sample 320-n).

In some examples, due to a periodical nature of cellular traffic (such as due to a periodical nature of human behavior of users) KPIs of the cells may have a periodical behavior (such as over one day, over one week, over one month, over one year) and may be relatively smooth (such that KPI value at 8:00 AM should be similar to that of 8:15 AM, 8:30 AM, and 8:45 AM). Accordingly, performance changes that may not be related to regular self-variability (such as performance changes due to configuration changes or due to a malfunction of an entity in the wireless network) may be observed in comparison to a same day of the week or range of days of the week (such as weekends, weekdays, or holidays), and within a threshold time (such as an hour of the day during the present week, one week before the present week, two weeks before the present week, and so on). Accordingly, the KPIs of the input samples 315 may include KPIs that were measured during a same day of the week, time of day, or range of days as KPIs collected following a configuration change. In some examples, the KPIs of the input samples 315 may exclude KPIs associated with holidays. For example, a shift in cellular traffic may occur during Christmas, and KPIs observed during Christmas may be omitted from the input samples 315 during non-holidays. Additionally, or alternatively, during Christmas, the KPIs observed during a previous Christmas (such as a Christmas on a previous year) may not be omitted from the input samples 315.

In some implementations, each of the encoder 305 and the decoder 310 may be respective sets of NNs (such as deep NNs). The NNs may be trained using a set of training data (such as KPIs of the cells that are not associated with a performance change that is not due to regular self-variability). For example, the DAE may identify one or more errors of each output sample 320 that may be typical of the DAE and of the set of cells (such as errors that may be present in examples in which a performance change due to a configuration change did not occur).

The DAE may determine that a performance change that is not due to regular self-variability (such as an anomaly due to a malfunction of a network entity) may have occurred if an error (such as a RMSE) between the input to the DAE and the decoded KPIs 225 is greater than an error threshold (such as a RMSE threshold). For example, the DAE may subtract the input sample 315-a and the output sample 320-a to generate a difference 325-a, and may subtract the input sample 315-n and the output sample 320-n to generate a difference 325-n, and so on for each input sample 315 and output sample 320. The DAE may determine if each difference 325 (such as each delta before and after compression) satisfies a threshold (such as a threshold for which the DAE may flag a performance change). In some examples, the threshold (such as an alert threshold, a sensitivity of the DAE) may be configured by the management device or by an MNO. In some examples, the DAE may determine (such as during the training operation) that each difference 325 (or a RMSE associated with each difference) may not satisfy the threshold (or the MSE threshold) in examples in which a performance change due to a configuration change did not occur. For example, during the training operation, one or more differences 325 or RMSEs computed by the DAE may not satisfy the threshold or the RMSE threshold. Accordingly, if a difference 325 satisfies the threshold, the DAE may determine that a performance change occurred that is not due to regular self-variance.

In some implementations, a frontend that may include one or more parametric models configured to perform parametric anomaly detection and classification may be located after the DAE. For example, the DAE may input the differences 325 into the frontend to generate an indication of whether a performance change (such as an anomaly) occurred and to classify the anomaly as an anomaly type (such as an anomaly type of a set of pre-specified anomaly types). The parametric models may include classical anomaly detection mechanisms that assume some pre-specified parametric distribution to the frontend input, such as a Gaussian distribution or Gaussian mixture distribution. If the anomaly is detected, the frontend may classify the anomaly into an anomaly class (such as an anomaly class of a set of pre-specified anomaly classes), such as a small and widespread anomaly (such as a small change in many cells or KPIs), or a large change in a single cell. The system (such as the DAE and the frontend) may indicate the anomaly type to the management device, and the management device may use the anomaly type to determine a solution. In the case of a classical anomaly, the solution could be a configuration rollback associated with the performance change. In the case of a small and widespread anomaly, for example a small degradation in throughput to all the cells of a given cluster where that cluster experienced a software upgrade, the solution may include rolling back the upgrade and restoring the previous software version.

The input samples 315 may include parameters X1, X2, X3, X4, X5, X6, and so on, which may be respective KPIs corresponding to respective cells of the group of cells. The output samples 320 may include parameters Y1, Y2, Y3, Y4, Y5, Y6, and so on (such as corresponding to each parameter of the input samples 315). As an illustrative example, X1 may be a throughput of a first cell at 8:00 AM on a previous Monday, X2 may be a throughput of the first cell at 8:00 AM on a current Monday, X3 may be a handoff success rate of the first cell at 8:00 AM on the previous Monday, X4 may be a handoff success rate of the first cell at 8:00 AM on the current Monday, X5 may be a throughput of a first cell at 8:00 AM on a previous Monday, and X6 may be a throughput of the second cell at 8:00 AM on the current Monday.

In some implementations, a compression rate of the DAE (such as a compression rate of the encoder 305) may be relatively high. Additionally, a throughput of each cell (such as the first cell and the second cell) may be relatively similar (such as within a threshold throughput) each week during a same weekday and a same time of day, and may be independent of one or more other KPIs of the set of cells (such as the handoff success rate, a DCR, and the like).

In some implementations, the NNs of the DAE may determine one or more correlations in the input samples 315, and the output samples 320 may be different from the input samples 315 based on such correlations. For example, for the parameters X1 and X2, the DAE may output the parameters Y1 and Y2 as an average of the throughput values of the first cell over the given two weeks of data (such as Y1=Y2=X1−X2/2). The DAE may perform a similar averaging for the second cell (such that Y5=Y6=X5−X6/2). The DAE may determine that a performance change (such as an anomaly) occurred for the first cell if a value X1−Y1 or a value X2−Y2 exceeds a threshold throughput difference, or for the second cell if a value X5−Y5 or a value X6−Y6 exceeds the threshold throughput difference.

The DAE may output an indication of the performance change to the management device. In some examples, if the performance change occurred for a given KPI (such as throughput) or for a given cell (such as the first cell), the DAE may output an indication of one or more KPIs or one or more cells associated with the performance change.

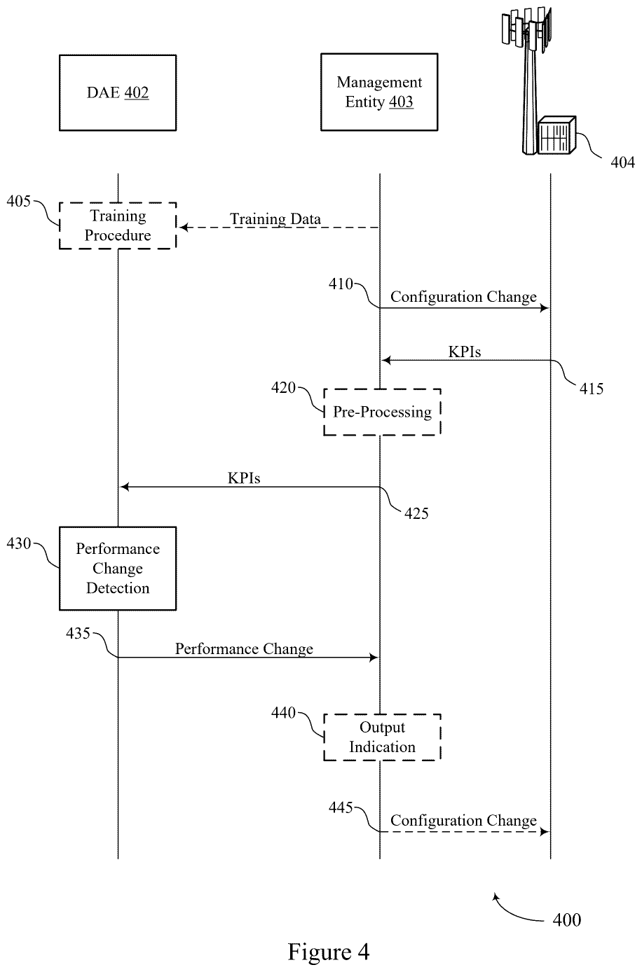

FIG. 4 shows an example of a process flow 400 that supports anomaly detection for network guards using DAEs. The process flow 400 may implement or may be implemented by aspects of the wireless communications system 100, the signaling diagram 200, or the DAE diagram 300. For example, the process flow 400 may be implemented by one or more cells 404 of network entities 105, which may be examples of network entities as described with reference to FIG. 1, and a management entity 403, which may be an example of an SMO 180 as described with reference to FIG. 1.

In the following description of the process flow 400, the operations between the DAE 402, the management entity 403, and the cells 404 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time.

In some examples, at 405, the DAE 402 may perform a training procedure. For example, the management entity 403 may train the DAE 402 (such as one or more NNs of the DAE) based on a set of training data. For example, the DAE 402 may encode the training data using a first set of NNs and may decode the encoded training data using a second set of NNs. The DAE 402 may compute a difference between the decoded training data and the initial input training data to determine a baseline of KPI differences associated with the training data.

The training data may include a first set of KPIs associated with one or more of a set of cells 404 (such as KPIs that may not include anomalies or abnormal performance changes). For example, the training data may include a drop rate, an access failure rate, a quantity of handover attempts, a quantity of successful handovers. a handover success rate, a throughput, a latency, an uplink traffic volume, or a downlink traffic volume. The training data may be associated with a specific time of day, a specific day of the week, or a specific range of days of the week (such as weekends or weekdays). In some examples (such as if the first set of KPIs are not associated with a holiday), the training data may exclude data collected during holidays. Additionally, or alternatively, if the first set of KPIs are associated with a holiday, the training data may not exclude data collected during holidays.

At 410, the management entity 403 may output a first configuration change to the set of cells 404. For example, the management entity 403 may indicate for one or more cells of the set of cells 404 to change a tilt, an azimuth, or a transmission power.

At 415, the set of cells 404 may indicate a set of KPIs to the management entity 403. The set of KPIs may include a drop rate, an access failure rate, a quantity of handover attempts, a quantity of successful handovers, a handover success rate, a throughput, a latency, an uplink traffic volume, or a downlink traffic volume. The set of KPIs may be associated with a specific time of day, a specific day of the week, or a specific range of days of the week (such as weekends or weekdays). For example, the set of KPIs may be associated with a same time of day, day of the week, or range of days of the week as the training data. In some examples, the set of KPIs may exclude data collected during holidays. In some examples, the set of KPIs may be associated with a specific season (such as a season during which the first set of KPIs was collected during a previous year).

In some examples, at 420, the management entity 403 may perform a pre-processing on the set of KPIs. For example, the management entity 403 may combine one or more KPIs of the set of KPIs (such as divide the quantity of handover attempts by quantity of successful handovers to determine a ratio of handover success), or may compute a likelihood value, a log likelihood value, or a normalized log likelihood value of the one or more KPIs.

At 425, the management entity 403 may provide the set of KPIs to the DAE 402. At 430, the DAE 402 may accordingly perform a performance change detection. For example, the DAE 402 may encode the set of KPIs (such as and one or more previous KPIs associated with the set of cells, such as the KPIs included in the training data) using the first set of NNs and may decode the encoded KPIs using the second set of NNs. The DAE 402 may subtract the KPIs input into the encoder and the output KPIs to generate a set of differences (such as for each KPI, for each cell, or both). In some examples, the DAE 402 (such as or the management entity 403) may determine that one or more of the set of differences are indicative of a performance change (such as an anomaly, a performance change that is different from a historic variance of the cells present in the training data) based on one or more of the differences being greater than a threshold difference or based on one or more MSEs associated with the one or more differences satisfying a threshold MSE.

At 435, the management entity 403 may receive an indication of the performance change (such as from the DAE 402). For example, the management entity 403 may receive an indication of the one or more differences, the one or more MSEs, and the like. In some examples, the indication may indicate one or more KPIs associated with the performance change, one or more cells of the set of cells 404 associated with the performance change, or both.

In some examples, at 440, the management entity 403 may output one or more messages indicating the performance change. For example, the management entity 403 may transmit a message indicating that the performance has changed to an MNO or to the set of cells 404. Additionally, or alternatively, at 445, the management entity 403 may output an indication of a second configuration change to the set of cells 440. For example, the management entity 403 may indicate for one or more cells of the set of cells 404 to change a tilt, an azimuth, or a transmission power. In some examples, the second configuration change may be a rollback of the first configuration change.

In some examples, the management entity 403 may output one or more messages indicating which KPI changed and for which cells. For example, the management entity 403 may observe for which cells and which of the KPIs the output of the DAE indicated increased errors (such as increased differences between the inputs and outputs of the DAE). Additionally, or alternatively, the management entity 403 may output one or more messages indicating when this change occurred (such as by determining dates and times for which the input samples to the DAE generated relatively larger errors).

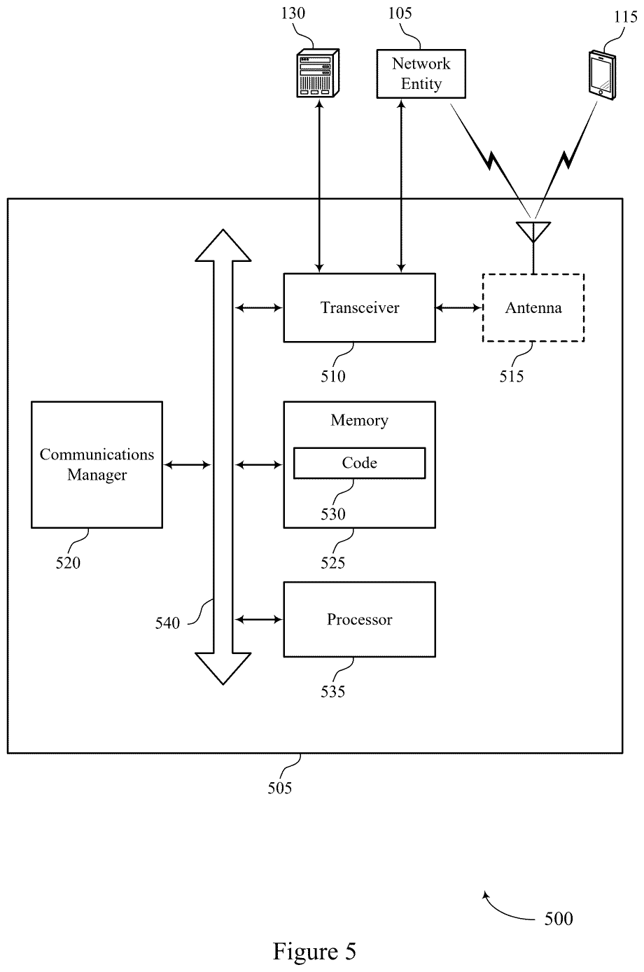

FIG. 5 shows a diagram of a system 500 including a device 505 that supports anomaly detection for network guards using DAEs. The device 505 may communicate with one or more network entities (such as one or more components of one or more network entities 105), one or more UEs 115, or any combination thereof, which may include communications over one or more wired interfaces, over one or more wireless interfaces, or any combination thereof. The device 505 may include components that support outputting and obtaining communications, such as a communications manager 520, a transceiver 510, one or more antennas 515, at least one memory 525, code 530, and at least one processor 535. These components may be in electronic communication or otherwise coupled (such as operatively, communicatively, functionally, electronically, electrically) via one or more buses (such as a bus 540).

The transceiver 510 may support bi-directional communications via wired links, wireless links, or both as described herein. In some examples, the transceiver 510 may include a wired transceiver and may communicate bi-directionally with another wired transceiver. Additionally, or alternatively, in some examples, the transceiver 510 may include a wireless transceiver and may communicate bi-directionally with another wireless transceiver. In some examples, the device 505 may include one or more antennas 515, which may be capable of transmitting or receiving wireless transmissions (such as concurrently). The transceiver 510 also may include a modem to modulate signals, to provide the modulated signals for transmission (such as by one or more antennas 515, by a wired transmitter), to receive modulated signals (such as from one or more antennas 515, from a wired receiver), and to demodulate signals. In some implementations, the transceiver 510 may include one or more interfaces, such as one or more interfaces coupled with the one or more antennas 515 that are configured to support various receiving or obtaining operations, or one or more interfaces coupled with the one or more antennas 515 that are configured to support various transmitting or outputting operations, or a combination thereof. In some implementations, the transceiver 510 may include or be configured for coupling with one or more processors or one or more memory components that are operable to perform or support operations based on received or obtained information or signals, or to generate information or other signals for transmission or other outputting, or any combination thereof. In some implementations, the transceiver 510, or the transceiver 510 and the one or more antennas 515, or the transceiver 510 and the one or more antennas 515 and one or more processors or one or more memory components (such as the at least one processor 535, the at least one memory 525, or both), may be included in a chip or chip assembly that is installed in the device 505. In some examples, the transceiver 510 may be operable to support communications via one or more communications links (such as communication link(s) 125, backhaul communication link(s) 120, a midhaul communication link 162, a fronthaul communication link 168).

The at least one memory 525 may include RAM, ROM, or any combination thereof. The at least one memory 525 may store computer-readable, computer-executable, or processor-executable code, such as the code 530. The code 530 may include instructions that, when executed by one or more of the at least one processor 535, cause the device 505 to perform various functions described herein. The code 530 may be stored in a non-transitory computer-readable medium such as system memory or another type of memory. In some implementations, the code 530 may not be directly executable by a processor of the at least one processor 535 but may cause a computer (such as when compiled and executed) to perform functions described herein. In some implementations, the at least one memory 525 may include, among other things, a BIOS which may control basic hardware or software operation such as the interaction with peripheral components or devices. In some examples, the at least one processor 535 may include multiple processors and the at least one memory 525 may include multiple memories. One or more of the multiple processors may be coupled with one or more of the multiple memories which may, individually or collectively, be configured to perform various functions herein (such as part of a processing system).

The at least one processor 535 may include one or more intelligent hardware devices (such as one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some implementations, the at least one processor 535 may be configured to operate a memory array using a memory controller. In some other implementations, a memory controller may be integrated into one or more of the at least one processor 535. The at least one processor 535 may be configured to execute computer-readable instructions stored in a memory (such as one or more of the at least one memory 525) to cause the device 505 to perform various functions (such as functions or tasks supporting anomaly detection for network guards using DAEs). For example, the device 505 or a component of the device 505 may include at least one processor 535 and at least one memory 525 coupled with one or more of the at least one processor 535, the at least one processor 535 and the at least one memory 525 configured to perform various functions described herein. The at least one processor 535 may be an example of a cloud-computing platform (such as one or more physical nodes and supporting software such as operating systems, virtual machines, or container instances) that may host the functions (such as by executing code 530) to perform the functions of the device 505. The at least one processor 535 may be any one or more suitable processors capable of executing scripts or instructions of one or more software programs stored in the device 505 (such as within one or more of the at least one memory 525).

In some examples, the at least one processor 535 may include multiple processors and the at least one memory 525 may include multiple memories. One or more of the multiple processors may be coupled with one or more of the multiple memories, which may, individually or collectively, be configured to perform various functions herein. In some examples, the at least one processor 535 may be a component of a processing system, which may refer to a system (such as a series) of machines, circuitry (including, for example, one or both of processor circuitry (which may include the at least one processor 535) and memory circuitry (which may include the at least one memory 525)), or components, that receives or obtains inputs and processes the inputs to produce, generate, or obtain a set of outputs. The processing system may be configured to perform one or more of the functions described herein. For example, the at least one processor 535 or a processing system including the at least one processor 535 may be configured to, configurable to, or operable to cause the device 505 to perform one or more of the functions described herein. Further, as described herein, being “configured to,” being “configurable to,” and being “operable to” may be used interchangeably and may be associated with a capability, when executing code stored in the at least one memory 525 or otherwise, to perform one or more of the functions described herein.

In some examples, a bus 540 may support communications of (such as within) a protocol layer of a protocol stack. In some examples, a bus 540 may support communications associated with a logical channel of a protocol stack (such as between protocol layers of a protocol stack), which may include communications performed within a component of the device 505, or between different components of the device 505 that may be co-located or located in different locations (such as where the device 505 may refer to a system in which one or more of the communications manager 520, the transceiver 510, the at least one memory 525, the code 530, and the at least one processor 535 may be located in one of the different components or divided between different components).

In some examples, the communications manager 520 may manage aspects of communications with a core network 130 (such as via one or more wired or wireless backhaul links). For example, the communications manager 520 may manage the transfer of data communications for client devices, such as one or more UEs 115. In some examples, the communications manager 520 may manage communications with one or more other network entities 105, and may include a controller or scheduler for controlling communications with UEs 115 (such as in cooperation with the one or more other network devices). In some examples, the communications manager 520 may support an X2 interface within an LTE/LTE-A wireless communications network technology to provide communication between network entities 105.

The communications manager 520 may support wireless communications in accordance with examples as disclosed herein. For example, the communications manager 520 is capable of, configured to, or operable to support a means for obtaining a set of multiple KPIs associated with a set of multiple cells of a wireless communications network. The communications manager 520 is capable of, configured to, or operable to support a means for receiving, in accordance with an output of a DAE, an indication of a performance change in at least one KPI of the set of multiple KPIs associated with the set of multiple cells. The communications manager 520 is capable of, configured to, or operable to support a means for outputting one or more messages in accordance with receiving the indication of the performance change.

In some examples, receiving the indication of the performance change is in accordance with computing one or more differences between the set of multiple KPIs and the output of the DAE.

In some examples, the communications manager 520 is capable of, configured to, or operable to support a means for training the DAE in accordance with a first set of KPI values associated with the set of multiple cells, where the first set of KPI values are associated with an absence of performance changes.

In some examples, the one or more differences are computed for each KPI of the set of multiple KPIs, for each cell of the set of multiple cells, or both.

In some examples, the indication of the performance change is in accordance with a MSE associated with the one or more differences satisfying a threshold MSE.

In some examples, to support receiving the indication of the performance change, the communications manager 520 is capable of, configured to, or operable to support a means for receiving an indication of a cell of the set of multiple cells associated with the performance change, an indication of a KPI type associated with the performance change, an indication of whether the performance change includes an improvement or a degradation, or any combination thereof.

In some examples, the set of multiple KPIs include KPIs from the set of multiple cells that are associated with a same day of the week, a same time of day, a same range of days of the week, or any combination thereof. In some examples, the set of multiple KPIs exclude one or more KPIs associated with a holiday.

In some examples, the communications manager 520 is capable of, configured to, or operable to support a means for performing a pre-processing of one or more KPIs of the set of multiple KPIs.

In some examples, to support performing the pre-processing, the communications manager 520 is capable of, configured to, or operable to support a means for combining the one or more KPIs of the set of multiple KPIs.

In some examples, to support performing the pre-processing, the communications manager 520 is capable of, configured to, or operable to support a means for computing a normalized log likelihood value, a log likelihood value, a likelihood value, or some combination thereof associated with the one or more KPIs of the set of multiple KPIs.

In some examples, to support outputting the one or more messages, the communications manager 520 is capable of, configured to, or operable to support a means for outputting an indication of the performance change to one or more of: a mobile network operator, and one or more cells of the set of multiple cells.

In some examples, the communications manager 520 is capable of, configured to, or operable to support a means for outputting, to one or more cells of the set of multiple cells, an indication of a first change in a configuration associated with the one or more cells, where the performance change is associated with the first change in the configuration. In some examples, the configuration includes one or more of: a tilt associated with the one or more cells of the set of multiple cells, an azimuth associated with the one or more cells of the set of multiple cells, a transmission power used by the one or more cells of the set of multiple cells, or any combination thereof.

In some examples, to support outputting the one or more messages, the communications manager 520 is capable of, configured to, or operable to support a means for outputting, to one or more cells of the set of multiple cells, an indication of a second change in the configuration associated with the one or more cells. In some examples, the second change includes a rollback of the first change.

In some examples, the DAE is configured to encode the set of multiple KPIs via a first one or more neural networks to generate an encoded set of multiple KPIs, to decode the encoded set of multiple KPIs via a second one or more neural networks to generate a decoded set of multiple KPIs, and to compute a difference between the set of multiple KPIs and the decoded set of multiple KPIs.

In some examples, a drop rate associated with one or more cells of the set of multiple cells, an access failure rate associated with one or more cells of the set of multiple cells, a quantity of handover attempts performed by one or more cells of the set of multiple cells, a quantity of successful handovers performed by one or more cells of the set of multiple cells, a throughput associated with one or more cells of the set of multiple cells, a latency associated with one or more cells of the set of multiple cells, an uplink traffic volume associated with one or more cells of the set of multiple cells, a downlink traffic volume associated with one or more cells of the set of multiple cells, or any combination thereof.

In some examples, the communications manager 520 may be configured to perform various operations (such as receiving, obtaining, monitoring, outputting, transmitting) using or otherwise in cooperation with the transceiver 510, the one or more antennas 515 (such as where applicable), or any combination thereof. Although the communications manager 520 is illustrated as a separate component, in some examples, one or more functions described with reference to the communications manager 520 may be supported by or performed by the transceiver 510, one or more of the at least one processor 535, one or more of the at least one memory 525, the code 530, or any combination thereof (such as by a processing system including at least a portion of the at least one processor 535, the at least one memory 525, the code 530, or any combination thereof). For example, the code 530 may include instructions executable by one or more of the at least one processor 535 to cause the device 505 to perform various aspects of anomaly detection for network guards using DAEs as described herein, or the at least one processor 535 and the at least one memory 525 may be otherwise configured to, individually or collectively, perform or support such operations.

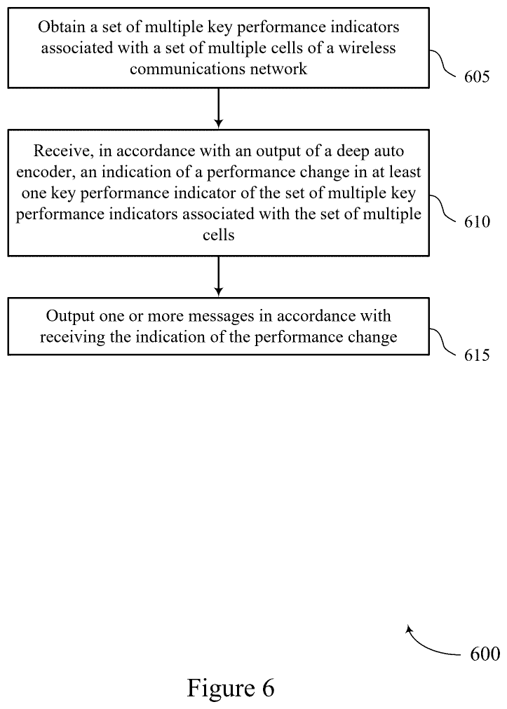

FIG. 6 shows a flowchart illustrating a method 600 that supports anomaly detection for network guards using DAEs. The operations of the method 600 may be implemented by a network entity or its components as described herein. For example, the operations of the method 600 may be performed by a network entity as described with reference to FIGS. 1 through 5. In some examples, a network entity may execute a set of instructions to control the functional elements of the network entity to perform the described functions. Additionally, or alternatively, the network entity may perform aspects of the described functions using special-purpose hardware.

At 605, the method may include obtaining a set of multiple KPIs associated with a set of multiple cells of a wireless communications network. The operations of 605 may be performed in accordance with examples as disclosed herein. In some examples, aspects of the operations of 605 may be performed by a communications manager 520 as described with reference to FIG. 5.

At 610, the method may include receiving, in accordance with an output of a DAE, an indication of a performance change in at least one KPI of the set of multiple KPIs associated with the set of multiple cells. The operations of 610 may be performed in accordance with examples as disclosed herein. In some examples, aspects of the operations of 610 may be performed by a communications manager 520 as described with reference to FIG. 5.

At 615, the method may include outputting one or more messages in accordance with receiving the indication of the performance change. The operations of 615 may be performed in accordance with examples as disclosed herein. In some examples, aspects of the operations of 615 may be performed by a communications manager 520 as described with reference to FIG. 5.

The following provides an overview of some aspects of the present disclosure:
Aspect 1: A method for wireless communications by a management entity, including: obtaining a set of multiple KPIs associated with a set of multiple cells of a wireless communications network; receiving, in accordance with an output of a DAE, an indication of a performance change in at least one KPI of the set of multiple KPIs associated with the set of multiple cells; and outputting one or more messages in accordance with receiving the indication of the performance change.
Aspect 2: The method of aspect 1, where receiving the indication of the performance change is in accordance with computing one or more differences between the set of multiple KPIs and the output of the DAE.
Aspect 3: The method of aspect 2, further including: training the DAE in accordance with a first set of KPI values associated with the set of multiple cells, where the first set of KPI values are associated with an absence of performance changes.
Aspect 4: The method of any of aspects 2 through 3, where the one or more differences are computed for each KPI of the set of multiple KPIs, for each cell of the set of multiple cells, or both.
Aspect 5: The method of any of aspects 2 through 4, where the indication of the performance change is in accordance with a MSE associated with the one or more differences satisfying a threshold MSE.
Aspect 6: The method of any of aspects 2 through 5, where receiving the indication of the performance change includes: receiving an indication of a cell of the set of multiple cells associated with the performance change, an indication of a KPI type associated with the performance change, an indication of whether the performance change includes an improvement or a degradation, or any combination thereof.
Aspect 7: The method of any of aspects 1 through 6, where the set of multiple KPIs include KPIs from the set of multiple cells that are associated with a same day of the week, a same time of day, a same range of days of the week, or any combination thereof.
Aspect 8: The method of any of aspects 1 through 7, where the set of multiple KPIs exclude one or more KPIs associated with a holiday.
Aspect 9: The method of any of aspects 1 through 8, further including: performing a pre-processing of one or more KPIs of the set of multiple KPIs.
Aspect 10: The method of aspect 9, where performing the pre-processing includes: combining the one or more KPIs of the set of multiple KPIs.
Aspect 11: The method of any of aspects 9 through 10, where performing the pre-processing includes: computing a normalized log likelihood value, a log likelihood value, a likelihood value, or some combination thereof associated with the one or more KPIs of the set of multiple KPIs.
Aspect 12: The method of any of aspects 1 through 11, where outputting the one or more messages includes: outputting an indication of the performance change to one or more of: a mobile network operator, and one or more cells of the set of multiple cells.
Aspect 13: The method of any of aspects 1 through 12, further including: outputting, to one or more cells of the set of multiple cells, an indication of a first change in a configuration associated with the one or more cells, where the performance change is associated with the first change in the configuration.
Aspect 14: The method of aspect 13, where outputting the one or more messages includes: outputting, to one or more cells of the set of multiple cells, an indication of a second change in the configuration associated with the one or more cells.
Aspect 15: The method of aspect 14, where the second change includes a rollback of the first change.
Aspect 16: The method of any of aspects 13 through 15, where the configuration includes one or more of: a tilt associated with the one or more cells of the set of multiple cells, an azimuth associated with the one or more cells of the set of multiple cells, a transmission power used by the one or more cells of the set of multiple cells, or any combination thereof.
Aspect 17: The method of any of aspects 1 through 16, where the DAE is configured to encode the set of multiple KPIs via a first one or more neural networks to generate an encoded set of multiple KPIs, to decode the encoded set of multiple KPIs via a second one or more neural networks to generate a decoded set of multiple KPIs, and to compute a difference between the set of multiple KPIs and the decoded set of multiple KPIs.
Aspect 18: The method of any of aspects 1 through 17, where the set of multiple KPIs include one or more of a drop rate associated with one or more cells of the set of multiple cells, an access failure rate associated with one or more cells of the set of multiple cells, a quantity of handover attempts performed by one or more cells of the set of multiple cells, a quantity of successful handovers performed by one or more cells of the set of multiple cells, a throughput associated with one or more cells of the set of multiple cells, a latency associated with one or more cells of the set of multiple cells, an uplink traffic volume associated with one or more cells of the set of multiple cells, a downlink traffic volume associated with one or more cells of the set of multiple cells, or any combination thereof.
Aspect 19: A management entity, including: a processing system that includes processor circuitry and memory circuitry that stores code, the processing system configured to cause the management entity to: obtain a set of multiple KPIs associated with a set of multiple cells of a wireless communications network; receive, in accordance with an output of a DAE, an indication of a performance change in at least one KPI of the set of multiple KPIs associated with the set of multiple cells; and output one or more messages in accordance with receiving the indication of the performance change.
Aspect 20: The management entity of aspect 19, where receiving the indication of the performance change is in accordance with computing one or more differences between the set of multiple KPIs and the output of the DAE.
Aspect 21: The management entity of aspect 20, where the processing system is further configured to cause the management entity to: train the DAE in accordance with a first set of KPI values associated with the set of multiple cells, where the first set of KPI values are associated with an absence of performance changes.
Aspect 22: The management entity of any of aspects 20 through 21, where the one or more differences are computed for each KPI of the set of multiple KPIs, for each cell of the set of multiple cells, or both.
Aspect 23: The management entity of any of aspects 20 through 22, where the indication of the performance change is in accordance with a MSE associated with the one or more differences satisfying a threshold MSE.
Aspect 24: The management entity of any of aspects 20 through 23, where, to receive the indication of the performance change, the processing system is configured to cause the management entity to: receive an indication of a cell of the set of multiple cells associated with the performance change, an indication of a KPI type associated with the performance change, an indication of whether the performance change includes an improvement or a degradation, or any combination thereof.
Aspect 25: The management entity of any of aspects 19 through 24, where the set of multiple KPIs include KPIs from the set of multiple cells that are associated with a same day of the week, a same time of day, a same range of days of the week, or any combination thereof.
Aspect 26: The management entity of any of aspects 19 through 25, where the set of multiple KPIs exclude one or more KPIs associated with a holiday.
Aspect 27: The management entity of any of aspects 19 through 26, where the processing system is further configured to cause the management entity to: perform a pre-processing of one or more KPIs of the set of multiple KPIs.
Aspect 28: The management entity of aspect 27, where, to perform the pre-processing, the processing system is configured to cause the management entity to: combine the one or more KPIs of the set of multiple KPIs.
Aspect 29: The management entity of any of aspects 27 through 28, where, to perform the pre-processing, the processing system is configured to cause the management entity to: compute a normalized log likelihood value, a log likelihood value, a likelihood value, or some combination thereof associated with the one or more KPIs of the set of multiple KPIs.
Aspect 30: The management entity of any of aspects 19 through 29, where, to output the one or more messages, the processing system is configured to cause the management entity to: output an indication of the performance change to one or more of: a mobile network operator, and one or more cells of the set of multiple cells.
Aspect 31: The management entity of any of aspects 19 through 30, where the processing system is further configured to cause the management entity to: output, to one or more cells of the set of multiple cells, an indication of a first change in a configuration associated with the one or more cells, where the performance change is associated with the first change in the configuration.
Aspect 32: The management entity of aspect 31, where, to output the one or more messages, the processing system is configured to cause the management entity to: output, to one or more cells of the set of multiple cells, an indication of a second change in the configuration associated with the one or more cells.
Aspect 33: The management entity of aspect 32, where the second change includes a rollback of the first change.
Aspect 34: The management entity of any of aspects 31 through 33, where, to, the processing system is configured to cause the management entity to: a tilt associate with the one or more cells of the set of multiple cells, an azimuth associated with the one or more cells of the set of multiple cells, a transmission power used by the one or more cells of the set of multiple cells, or any combination thereof.
Aspect 35: The management entity of any of aspects 19 through 34, where the DAE is configured to encode the set of multiple KPIs via a first one or more neural networks to generate an encoded set of multiple KPIs, to decode the encoded set of multiple KPIs via a second one or more neural networks to generate a decoded set of multiple KPIs, and to compute a difference between the set of multiple KPIs and the decoded set of multiple KPIs.
Aspect 36: The management entity of any of aspects 19 through 35, where a drop rate associated with one or more cells of the set of multiple cells, an access failure rate associated with one or more cells of the set of multiple cells, a quantity of handover attempts performed by one or more cells of the set of multiple cells, a quantity of successful handovers performed by one or more cells of the set of multiple cells, a throughput associated with one or more cells of the set of multiple cells, a latency associated with one or more cells of the set of multiple cells, an uplink traffic volume associated with one or more cells of the set of multiple cells, a downlink traffic volume associated with one or more cells of the set of multiple cells, or any combination thereof.
Aspect 37: A management entity for wireless communications, including: means for obtaining a set of multiple KPIs associated with a set of multiple cells of a wireless communications network; means for receiving, in accordance with an output of a DAE, an indication of a performance change in at least one KPI of the set of multiple KPIs associated with the set of multiple cells; and means for outputting one or more messages in accordance with receiving the indication of the performance change.
Aspect 38: A non-transitory computer-readable medium storing code for wireless communications, the code including instructions executable by one or more processors to: obtain a set of multiple KPIs associated with a set of multiple cells of a wireless communications network; receive, in accordance with an output of a DAE, an indication of a performance change in at least one KPI of the set of multiple KPIs associated with the set of multiple cells; and output one or more messages in accordance with receiving the indication of the performance change.
Aspect 39: The non-transitory computer-readable medium of aspect 38, where receiving the indication of the performance change is in accordance with computing one or more differences between the set of multiple KPIs and the output of the DAE.
Aspect 40: The non-transitory computer-readable medium of aspect 39, where the instructions are further executable by the one or more processors to: train the DAE in accordance with a first set of KPI values associated with the set of multiple cells, where the first set of KPI values are associated with an absence of performance changes.
Aspect 41: The non-transitory computer-readable medium of any of aspects 39 through 40, where the one or more differences are computed for each KPI of the set of multiple KPIs, for each cell of the set of multiple cells, or both.
Aspect 42: The non-transitory computer-readable medium of any of aspects 39 through 41, where the indication of the performance change is in accordance with a MSE associated with the one or more differences satisfying a threshold MSE.
Aspect 43: The non-transitory computer-readable medium of any of aspects 39 through 42, wherein the code to receive the indication of the performance change are executable by the one or more processors to: receive an indication of a cell of the set of multiple cells associated with the performance change, an indication of a KPI type associated with the performance change, an indication of whether the performance change includes an improvement or a degradation, or any combination thereof.
Aspect 44: The non-transitory computer-readable medium of any of aspects 38 through 43, where the set of multiple KPIs include KPIs from the set of multiple cells that are associated with a same day of the week, a same time of day, a same range of days of the week, or any combination thereof.
Aspect 45: The non-transitory computer-readable medium of any of aspects 38 through 44, where the set of multiple KPIs exclude one or more KPIs associated with a holiday.
Aspect 46: The non-transitory computer-readable medium of any of aspects 38 through 45, where the instructions are further executable by the one or more processors to: perform a pre-processing of one or more KPIs of the set of multiple KPIs.
Aspect 47: The non-transitory computer-readable medium of aspect 46, wherein the code to perform the pre-processing are executable by the one or more processors to: combine the one or more KPIs of the set of multiple KPIs.
Aspect 48: The non-transitory computer-readable medium of any of aspects 46 through 47, wherein the code to perform the pre-processing are executable by the one or more processors to: compute a normalized log likelihood value, a log likelihood value, a likelihood value, or some combination thereof associated with the one or more KPIs of the set of multiple KPIs.
Aspect 49: The non-transitory computer-readable medium of any of aspects 38 through 48, wherein the code to output the one or more messages are executable by the one or more processors to: output an indication of the performance change to one or more of: a mobile network operator, and one or more cells of the set of multiple cells.
Aspect 50: The non-transitory computer-readable medium of any of aspects 38 through 49, where the instructions are further executable by the one or more processors to: output, to one or more cells of the set of multiple cells, an indication of a first change in a configuration associated with the one or more cells, where the performance change is associated with the first change in the configuration.
Aspect 51: The non-transitory computer-readable medium of aspect 50, wherein the code to output the one or more messages are executable by the one or more processors to: output, to one or more cells of the set of multiple cells, an indication of a second change in the configuration associated with the one or more cells.
Aspect 52: The non-transitory computer-readable medium of aspect 51, where the second change includes a rollback of the first change.
Aspect 53: The non-transitory computer-readable medium of any of aspects 50 through 52, wherein the code to are executable by the one or more processors to: a tilt associate with the one or more cells of the set of multiple cells, an azimuth associated with the one or more cells of the set of multiple cells, a transmission power used by the one or more cells of the set of multiple cells, or any combination thereof.
Aspect 54: The non-transitory computer-readable medium of any of aspects 38 through 53, where the DAE is configured to encode the set of multiple KPIs via a first one or more neural networks to generate an encoded set of multiple KPIs, to decode the encoded set of multiple KPIs via a second one or more neural networks to generate a decoded set of multiple KPIs, and to compute a difference between the set of multiple KPIs and the decoded set of multiple KPIs.
Aspect 55: The non-transitory computer-readable medium of any of aspects 38 through 54, where a drop rate associated with one or more cells of the set of multiple cells, an access failure rate associated with one or more cells of the set of multiple cells, a quantity of handover attempts performed by one or more cells of the set of multiple cells, a quantity of successful handovers performed by one or more cells of the set of multiple cells, a throughput associated with one or more cells of the set of multiple cells, a latency associated with one or more cells of the set of multiple cells, an uplink traffic volume associated with one or more cells of the set of multiple cells, a downlink traffic volume associated with one or more cells of the set of multiple cells, or any combination thereof.
Aspect 56: A management entity for wireless communications, including: processing circuitry associated with one or more memory devices and configured to cause the management entity to: obtain a set of multiple KPIs associated with a set of multiple cells of a wireless communications network; receive, in accordance with an output of a DAE, an indication of a performance change in at least one KPI of the set of multiple KPIs associated with the set of multiple cells; and output one or more messages in accordance with receiving the indication of the performance change.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data stored in memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented using hardware or software depends upon the particular application and design constraints imposed on the overall system.

The hardware and data processing apparatus used to implement the various illustrative logics, logical blocks, modules and circuits described in connection with the aspects disclosed herein may be implemented or performed using a general purpose single- or multi-chip processor, a digital signal processor (DSP), an application specific integrated circuit (ASIC), a graphics processing unit (GPU), a neural processing unit (NPU), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented using hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted using one or more instructions or code of a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one location to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc. Disks may reproduce data magnetically and discs may reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

1. A management entity, comprising:
a processing system that includes processor circuitry and memory circuitry that stores code, the processing system configured to cause the management entity to:
obtain a plurality of key performance indicators associated with a plurality of cells of a wireless communications network;
receive, in accordance with an output of a deep auto encoder, an indication of a performance change in at least one key performance indicator of the plurality of key performance indicators associated with the plurality of cells; and
output one or more messages in accordance with receiving the indication of the performance change.

2. The management entity of claim 1, wherein receiving the indication of the performance change is in accordance with computing one or more differences between the plurality of key performance indicators and the output of the deep auto encoder.

3. The management entity of claim 2, wherein the processing system is further configured to cause the management entity to:
train the deep auto encoder in accordance with a first set of key performance indicator values associated with the plurality of cells, wherein the first set of key performance indicator values are associated with an absence of performance changes.

4. The management entity of claim 2, wherein the one or more differences are computed for each key performance indicator of the plurality of key performance indicators, for each cell of the plurality of cells, or both.

5. The management entity of claim 2, wherein the indication of the performance change is in accordance with a mean-squared error associated with the one or more differences satisfying a threshold mean-squared error.

6. The management entity of claim 2, wherein, to receive the indication of the performance change, the processing system is configured to cause the management entity to:
receive an indication of a cell of the plurality of cells associated with the performance change, an indication of a key performance indicator type associated with the performance change, an indication of whether the performance change comprises an improvement or a degradation, or any combination thereof.

7. The management entity of claim 1, wherein the plurality of key performance indicators comprise key performance indicators from the plurality of cells that are associated with a same weekday, a same time of day, a same range of weekdays, or any combination thereof.

8. The management entity of claim 1, wherein the plurality of key performance indicators exclude one or more key performance indicators associated with a holiday.

9. The management entity of claim 1, wherein the processing system is further configured to cause the management entity to:
perform a pre-processing of one or more key performance indicators of the plurality of key performance indicators.

10. The management entity of claim 9, wherein, to perform the pre-processing, the processing system is configured to cause the management entity to:
combine the one or more key performance indicators of the plurality of key performance indicators.

11. The management entity of claim 9, wherein, to perform the pre-processing, the processing system is configured to cause the management entity to:
compute a normalized log likelihood value, a log likelihood value, a likelihood value, or some combination thereof associated with the one or more key performance indicators of the plurality of key performance indicators.

12. The management entity of claim 1, wherein, to output the one or more messages, the processing system is configured to cause the management entity to:
output an indication of the performance change to one or more of: a mobile network operator, and one or more cells of the plurality of cells.

13. The management entity of claim 1, wherein the processing system is further configured to cause the management entity to:
output, to one or more cells of the plurality of cells, an indication of a first change in a configuration associated with the one or more cells, wherein the performance change is associated with the first change in the configuration.

14. The management entity of claim 13, wherein, to output the one or more messages, the processing system is configured to cause the management entity to:
output, to one or more cells of the plurality of cells, an indication of a second change in the configuration associated with the one or more cells.

15. The management entity of claim 14, wherein the second change comprises a rollback of the first change.

16. The management entity of claim 13, wherein the configuration comprises one or more of a tilt associate with the one or more cells of the plurality of cells, an azimuth associated with the one or more cells of the plurality of cells, a transmission power used by the one or more cells of the plurality of cells, or any combination thereof.

17. The management entity of claim 1, wherein the deep auto encoder is configured to encode the plurality of key performance indicators via a first one or more neural networks to generate an encoded plurality of key performance indicators, to decode the encoded plurality of key performance indicators via a second one or more neural networks to generate a decoded plurality of key performance indicators, and to compute a difference between the plurality of key performance indicators and the decoded plurality of key performance indicators.

18. The management entity of claim 1, wherein a drop rate associated with one or more cells of the plurality of cells, an access failure rate associated with one or more cells of the plurality of cells, a quantity of handover attempts performed by one or more cells of the plurality of cells, a quantity of successful handovers performed by one or more cells of the plurality of cells, a throughput associated with one or more cells of the plurality of cells, a latency associated with one or more cells of the plurality of cells, an uplink traffic volume associated with one or more cells of the plurality of cells, a downlink traffic volume associated with one or more cells of the plurality of cells, or any combination thereof.

19. A method for wireless communications by a management entity, comprising:
obtaining a plurality of key performance indicators associated with a plurality of cells of a wireless communications network;
receiving, in accordance with an output of a deep auto encoder, an indication of a performance change in at least one key performance indicator of the plurality of key performance indicators associated with the plurality of cells; and
outputting one or more messages in accordance with receiving the indication of the performance change.

20. The method of claim 19, wherein receiving the indication of the performance change is in accordance with computing one or more differences between the plurality of key performance indicators and the output of the deep auto encoder.

21-36. (canceled)
